(19) United States
(12) Patent Application Publication
(10) Pub. No.: US 2025/0377662 A1
(43) Pub. Date: Dec. 11, 2025

(54) SYSTEM AND METHOD FOR TRACKING MOVEMENT OF A VEHICLE

(71) Applicant: THE BOEING COMPANY, Arlington, VA (US)

(72) Inventors: Justin David Bailey, Snohomish, WA (US); Steven Patrick Hatter, Tulalip, WA (US); Chia Chang John Chuang, Everett, WA (US); Derek Conrad Andricos, Bellingham, WA (US)

(73) Assignee: THE BOEING COMPANY, Arlington, VA (US)

(21) Appl. No.: 18/739,518

(22) Filed: Jun. 11, 2024

(51) Int. Cl. G05D 1/244; G05D 107/70; G05D 109/20; G05D 111/10

(52) U.S. Cl. CPC G05D 1/244; G05D 2107/70; G05D 2109/20; G05D 2111/14

(57) ABSTRACT

A system and a method include an alignment strip coupled to a surface. A vehicle is configured to move over the surface. The vehicle includes an ultraviolet (UV) light emitter configured to emit UV light onto the alignment strip. The UV light emitted by the UV light emitter illuminates the alignment strip. An imaging device is configured to acquire one or more images of the alignment strip as illuminated by the UV light.

### FIELD OF THE DISCLOSURE

Examples of the present disclosure generally relate to systems and methods for tracking movement of a vehicle, and, more particularly, to ensuring proper aligned movement of a vehicle during operation.

### BACKGROUND OF THE DISCLOSURE

Aircraft are used to transport passengers and cargo between various locations. Numerous aircraft depart from and arrive at a typical airport every day.

As an aircraft is being manufactured, various portions can be moved within a factory by automated guided vehicles. The automated guided vehicles include vision guidance systems that are used to ensure that the aircraft is moved and/or maintained at a desired configuration. A vision guidance system includes an equipment camera that acquires images of a line painted on a floor of the factory. The equipment camera includes software that is configured to identify and follow the painted line to ensure desired movement of the automated guided vehicle within the factory.

However, over time, the painted line can fade, become distorted, hidden by objects, and/or otherwise affected, such as by vehicles repeatedly moving over portions of the painted line. In such instances, the painted line may not be effectively detected by the equipment camera, which can lead to faults in the vision guidance system. Therefore, the painted line may need to be repainted for the vision guidance system to effectively operate. As can be appreciated, clearing and re-painting the line is time- and labor-intensive, which can delay an overall manufacturing process.

### SUMMARY OF THE DISCLOSURE

A need exists for an efficient and effective system and method for ensuring a desired alignment of a vehicle, such as an automated guided vehicle. Further, a need exists for a system and a method that provide a robust, resilient, and effective alignment indicia for a vehicle, such as an automated guided vehicle. Also, a need exists for a system and a method that leads to an efficient and effective manufacturing process, such as for an aircraft.

With those needs in mind, certain examples of the present disclosure provide a system including an alignment strip coupled to a surface, and a vehicle configured to move over the surface. The vehicle includes an ultraviolet (UV) light emitter configured to emit UV light onto the alignment strip. The UV light emitted by the UV light emitter illuminates the alignment strip. An imaging device is configured to acquire one or more images of the alignment strip as illuminated by the UV light.

In at least one example, a control unit is in communication with the imaging device. The control unit is configured to receive image data including the one or more images from the imaging device. The control unit is further configured to use the one or more images to one or both of track movement of the vehicle, or control the movement of the vehicle.

The surface can be a floor within a factory. As another example, the surface can be a road.

In at least one example, the imaging device is an equipment camera configured to acquire black and white images or videos.

The UV light emitter can be configured to emit the UV light at a wavelength of 365 nanometers.

In at least one example, the alignment strip is retained within a channel formed into a top of the surface. In at least one example, the alignment strip is an acrylic strip. As a further example, the acrylic strip is colored fluorescent neon green. In at least one example, the surface includes a dark backdrop against the acrylic strip.

Certain examples of the present disclosure provide a method including emitting, by the UV light emitter, UV light onto the alignment strip; illuminating, by the UV light, the alignment strip; and acquiring, by the imaging device, one or more images of the alignment strip as illuminated by the UV light.

### BRIEF DESCRIPTION OF THE DRAWINGS

FIG. 1 illustrates a block diagram of a system, according to an example of the present disclosure.

FIG. 2 illustrates a perspective view of an alignment strip coupled to a surface, according to an example of the present disclosure.

FIG. 3 illustrates a perspective side view of a vehicle supported on the surface having the alignment strip, according to an example of the present disclosure.

FIG. 4 illustrates a perspective side view of a vehicle supported on the surface having the alignment strip, according to an example of the present disclosure.

FIG. 5 illustrates a perspective interior view of a factory, according to an example of the present disclosure.

FIG. 6 illustrates a schematic block diagram of a control unit, according to an example of the present disclosure.

FIG. 7 illustrates a perspective front view of an aircraft, according to an example of the present disclosure.

FIG. 8 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

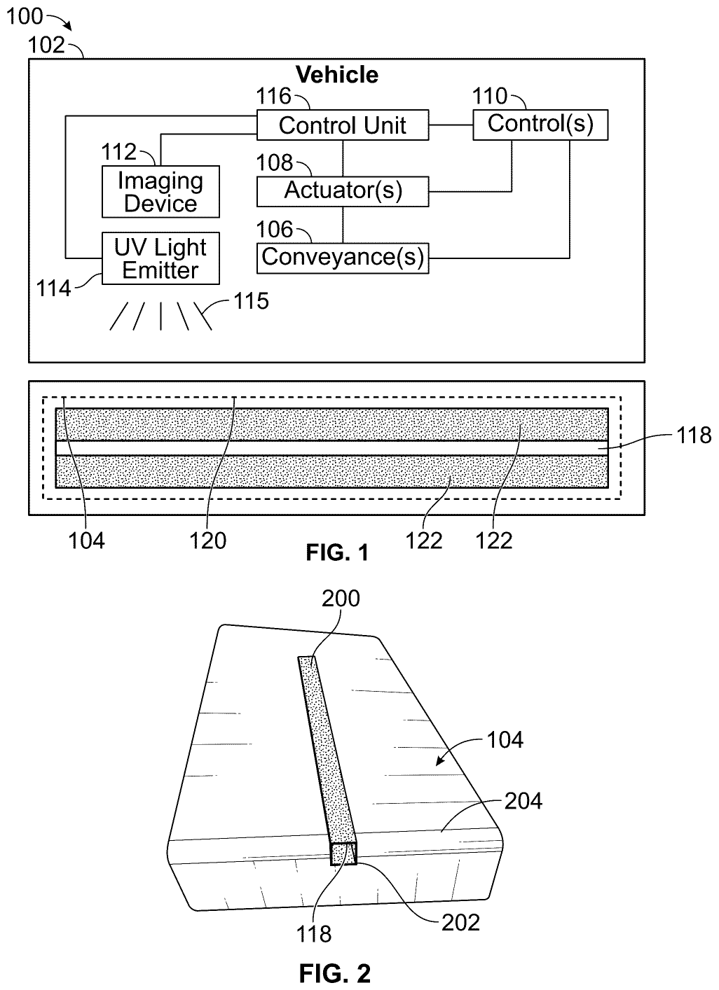

FIG. 1 illustrates a block diagram of a system 100, according to an example of the present disclosure. The system 100 includes a vehicle 102 configured to be supported on and move over a surface 104, such as a floor, ground, a road, a path, or the like. In at least one example, the surface 104 is a floor of a factory. In at least one example, the vehicle 102 is an automated guided vehicle used to support and transport a vehicle, such as a commercial aircraft, during a manufacturing process. For example, the vehicle 102 can be an automated support vehicle having one or more drive wheels. As another example, the vehicle 102 can be an automated jack tower used to support wings and/or a fuselage. As another example, the vehicle 102 can be an automobile, a bus, or the like, and the surface 104 can be a road. The automobile or bus can be an electric, self-guiding car, for example.

The vehicle 102 includes one or more conveyances 106, such as one or more wheels, one or more tracks, one or more powered feet or legs, one or more air emitters (such as used with hovercrafts), one or more magnetic levitation devices, and/or the like. One or more actuators 108 are operatively coupled to the conveyances 106. The actuators 108 can include electric motors, As another example, the actuators 108 can include an internal combustion engine. As another example, the actuators 108 and conveyances 106 can include or otherwise be part of a magnetic levitation (maglev) system.

One or more controls 110 are operatively coupled to the actuators 108 and/or the conveyances 106. The controls 110 can include a steering wheel or stick, a yoke, brakes, and the like.

The vehicle 102 also includes an imaging device 112 and an ultraviolet (UV) light emitter 114. In at least one example, the imaging device 112 is a photographic camera or a video camera. As a further example, the imaging device 112 can be a dedicated equipment camera configured to identify and follow particular features, such as alignment indicators. In at least one example, the imaging device 112 is an equipment camera configured to acquire black and white images or videos. As another example, the imaging device 112 can be configured to acquire color images or videos.

The UV light emitter 114 is configured to emit UV light 115 onto the surface 104. As an example, the UV light emitter 114 is configured to emit the UV light 115 at a wavelength within a range of 300-400 nanometers (nm). As a further example, the UV light emitter 114 is configured to emit the UV light at a wavelength of 365 nm. Optionally, the UV light emitter 114 can be configured to emit the UV light 115 at various other wavelengths, such as between 200 nm-230 nm, between 230 nm-280 nm, or the like.

The vehicle 102 also includes a control unit 116 in communication with the imaging device 112 and the UV light emitter 114, such as through one or more wired or wireless connections. As shown, the control unit 116 can be separate and distinct from the imaging device 112 and the UV light emitter 114. As another example, the imaging device 112 can include the control unit 116, which can include hardware and software for identifying and following features on the surface 104. As another example, the control unit 116 can be separate and distinct from the vehicle 102. For example, the control unit 116 can be part of a computer workstation, handheld device, or the like in communication with the imaging device 112 and the UV light emitter 114.

The control unit 116 can be in communication with one or more of the control(s) 110, the actuator(s) 108, and/or the conveyance(s) 106, such as through one or more wired or wireless connections. In at least one example, the control unit 116 is configured to automatically operate the vehicle 102, such as through automatic control of the control(s) 110, the actuator(s) 108, and/or the conveyance(s) 106. Optionally, the control unit 116 may not be configured to automatically operate the vehicle 102. Also, optionally, the control unit 116 may not be in communication with one or more of the control(s) 110, the actuator(s) 108, and/or the conveyance(s) 106.

In order to ensure that the vehicle 102 moves at a desired orientation (such as when supporting a portion of an aircraft at a desired aligned configuration), the surface 104 includes one or more alignment strips 118, which are contrasted against a dark backdrop 122 (for example, a black dyed or gray dye area). The alignment strip(s) 118 are coupled to the surface 104. For example, the alignment strip(s) 118 are secured to an exposed top 120 of the surface 104. The alignment strip(s) 118 are exposed on the top 120 of the surface 104. In at least one example, the alignment strip(s) 118 are retained within one or more channels formed in the surface 104. As a further example, the alignment strip(s) 118 are secured within the channel(s) through an interference fit. As another example, the alignment strip(s) 118 to one or more tracks mounted on the top 120 of the surface 104.

In at least one example, the alignment strip 118 is an acrylic strip. Portions of the surface 104 abutting the acrylic strip can be a dark contrast color, such as black or gray, such as the dark backdrop 122. For example, areas of the surface 104 (such as the dark backdrop 122) to either side of the acrylic strip can be painted gray or black, or optionally, can be integrally colored gray or black. In at least one example, the acrylic strip is a molded longitudinal body of acrylic. It has been found that the molded acrylic strip is well-suited for being inserted and retained within a reciprocal channel formed in the surface 104. As another example, the acrylic strip can be an extruded longitudinal piece of acrylic. In at least one example, the acrylic strip is colored fluorescent neon green. It has been found that a fluorescent neon green provides a readily discernable contrast with a grey or black surface 104, such as when viewed by the imaging device 112. Optionally, the acrylic strip can be various other colors, such as yellow, blue, red, or the like.

In operation, in order to ensure proper orientation of the vehicle 102 during movement, the UV light emitter 114 emits the UV light 115 onto the surface 104, including the alignment strip 118. The UV light 115 illuminates the alignment strip 118 contrasted against the dark backdrop 122 of the surface 104. For example, as the UV light 115 impinges the alignment strip 118, the alignment strip 118 (such as a fluorescent acrylic strip) fluoresces (such by reflecting the UV light 115, and/or emitting UV light). It has been found that UV light 115 emitted at 365 nm causes the alignment strip 118 (in particular, a fluorescent neon green acrylic strip) to fluoresce and sharply contrast with the dark portions of the surface 104 surrounding the alignment strip 118. The imaging device 112 acquires one or more images of the alignment strip 118 (as illuminated by the UV light 115) contrasting against dark portions of the surface 104.

The images of the alignment strip 118, as acquired by the imaging device 112, are used to track and/or control movement of the vehicle 102. The control unit 116 receives signals from the imaging device 112 that include the images of the alignment strip 118 contrasted with the dark portions of the surface 104. The control unit 116 then detects the edge surfaces of the alignment strips 118 from the images, which are used to ensure a desired alignment of the vehicle 102 during movement. In at least one example, the control unit 116 automatically controls and operates the vehicle 102 by using the images of the alignment strip 118 (which fluoresces due to the impingement of the UV light 115 emitted from the UV light emitter 114) contrasted with darker portions of the surface 104. As noted, the imaging device 112 can be an equipment camera that acquires black and white images. The images include the alignment strip 118, which appears as a readily discernable white having sharp boundaries, against the dark of the surrounding surface 104.

As described, in at least one example, the alignment strip 118 is formed of fluorescent neon green acrylic. Optionally, the alignment strip 118 can be other fluorescent colors. The alignment strip 118 fluoresces in response to the UV light 115 impinging the alignment strip 118. The imaging device 112 acquires images (such as photographic or video images) of the alignment strip 118 contrasted against the darker portions of the surface 104 by the alignment strip 118.

As noted, in at least one example, portions of the surface 104 proximate to (such as directly abutting, surrounding, and/or the like) the alignment strip 118 are darker than the alignment strip 118. For example, the surface 104 includes the dark backdrop 122 proximate to (such as abutting against side of) the alignment strip 118. In at least one example, the dark backdrop 122 is an area that is painted or stained black or gray. Optionally, the surface 104 may not include the dark backdrop 122, but may be naturally dark and readily contrasted with the alignment strip 118.

As described herein, the system 100 includes the alignment strip 118 coupled to the surface 104. The vehicle 102 is configured to move over the surface 104. The vehicle 102 includes the UV light emitter 114 configured to emit UV light 115 onto the alignment strip 118. The UV light 115 emitted by the UV light emitter 114 illuminates the alignment strip 118. The imaging device 112 is configured to acquire one or more images of the alignment strip 118 as illuminated by the UV light 115.

The images are then used to track and/or control movement of the vehicle 102. For example, the control unit 116 is configured to receive image data including the one or more images from the imaging device 112. The control unit 116 can be further configured to use the one or more images (such as via image analysis) to track movement of the vehicle 102, and/or control the movement of the vehicle 102.

FIG. 2 illustrates a perspective view of the alignment strip 118 coupled to the surface 104, according to an example of the present disclosure. In at least one example, the surface 104 is a portion of a floor within a factory. As another example, the surface 104 is a portion of a road. The surface 104 can be formed from concrete, for example. An upper portion of the surface 104 can be painted, stained, died, or otherwise colored black.

In at least one example, the alignment strip 118 is an acrylic strip 200, which can be fluorescent neon green in color. The acrylic strip 200 is retained within a reciprocal channel 202 formed into a top 204 of the surface 104.

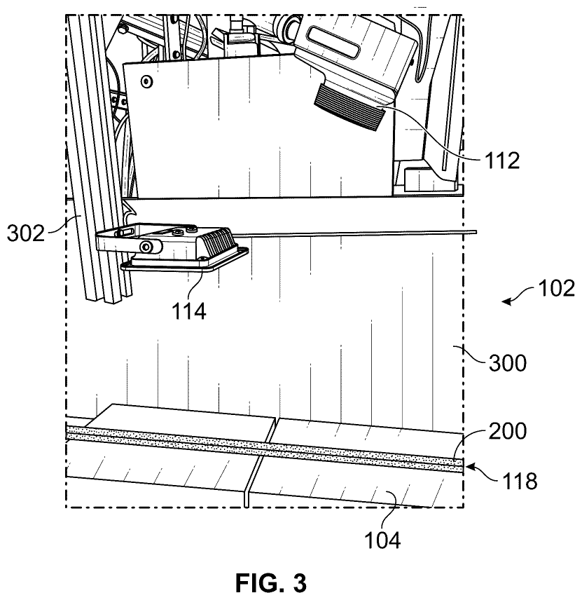

FIG. 3 illustrates a perspective side view of a vehicle 102 supported on the surface having the alignment strip, according to an example of the present disclosure. Referring to FIGS. 1-3, in at least one example, the vehicle 102 is an automated guided vehicle configured to support portions of an aircraft during a manufacturing process. The vehicle 102 includes a main body 300 that supports the imaging device 112, and the UV light emitter 114. For example, a support bracket 302 can extend from a portion of the main body 300 and hold the UV light emitter 114 at a desired height in relation to the surface 104. Similarly, the main body 300 can retain the imaging device 112 at a desired position in relation to the surface 104 and the UV light emitter 114 to ensure that the imaging device 112 acquires images of the alignment strip 118 as illuminated by the UV light 115 emitted by the UV light emitter 114. For example, the UV light emitter 114 can be spaced from the imaging device 112 a distance, such as within 3 feet or less. As a further example, the UV light emitter 114 can be spaced from the imaging device 112 a distance of 4 inches or less. Further, the UV light emitter 114 can be spaced from the top of the surface 104 a distance of 3 feet or less. As a further example, the UV light emitter 114 is spaced from the top of the surface 104 a distance of 9 inches or less.

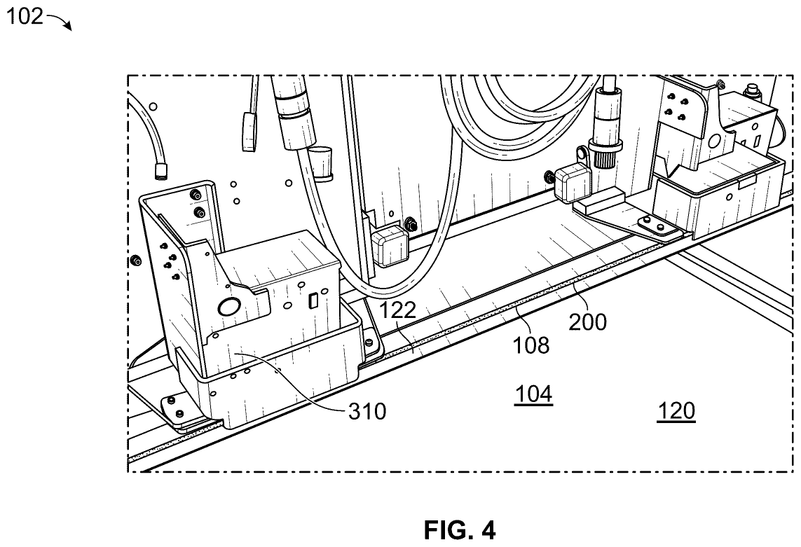

FIG. 4 illustrates a perspective side view of a vehicle 102 supported on the surface 104 having the alignment strip 118, according to an example of the present disclosure. As shown, the dark backdrop 122 abuts against sides of the alignment strip 118, thereby providing a readily discernable contrast therebetween.

In at least one example, the vehicle 102 includes a housing 310, which can be disposed over a conveyance, such as a wheel. Referring to FIGS. 1 and 4, the housing 310 retains the imaging device 112 and the UV light emitter 114. The housing 310 provides a protective shroud for the imaging device 112 and the UV light emitter 114. Optionally, the imaging device 112 and the UV light emitter 114 may not be within a housing.

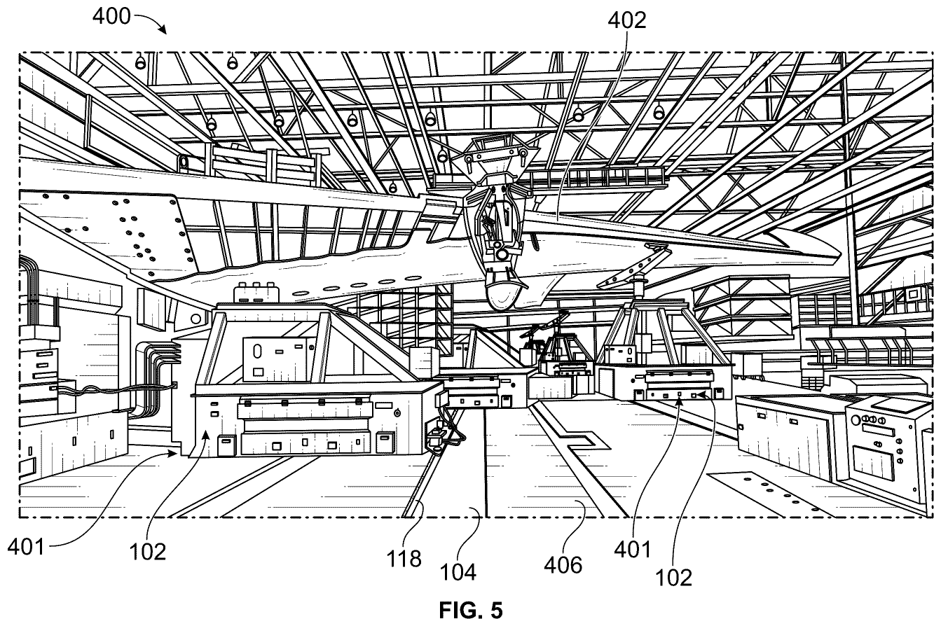

FIG. 5 illustrates a perspective interior view of a factory 400, according to an example of the present disclosure. An aircraft can be assembled within the factory 400. Referring to FIGS. 1-5, vehicles 102, such as automated jack towers 401, are used to support and move portions of the aircraft, such as wings 402, over the surface 104, such as a floor 406 of the factory 400. Alignment strips 118 are coupled to the floor 406, as described herein.

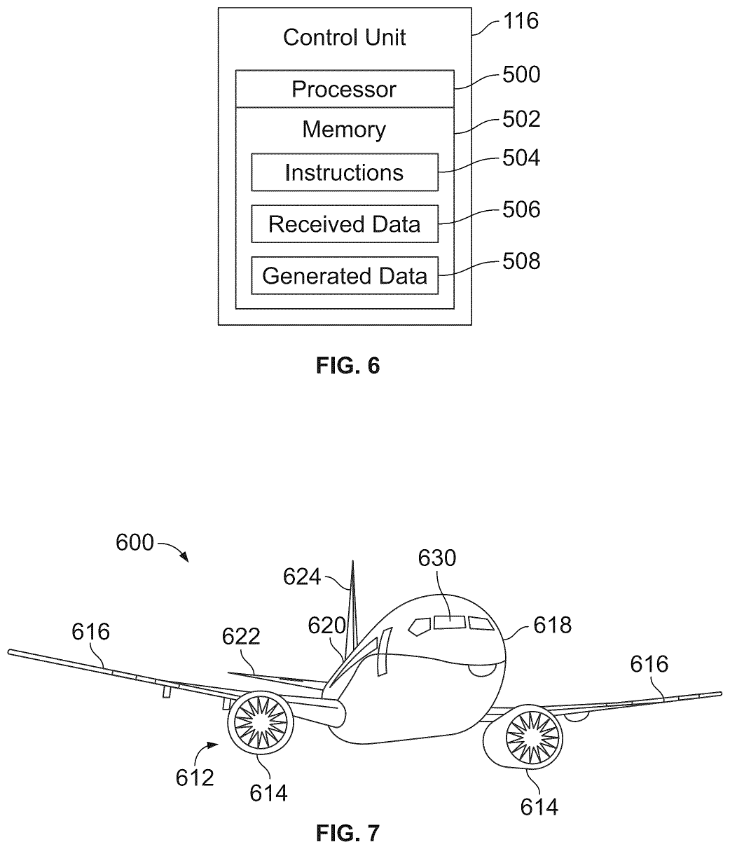

FIG. 6 illustrates a schematic block diagram of the control unit 116, according to an example of the present disclosure. In at least one example, the control unit 116 includes at least one processor 500 in communication with a memory 502. The memory 502 stores instructions 504, received data 506, and generated data 508. The control unit 116 shown in FIG. 6 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 116 may be or include one or more processors that are configured to control operation, as described herein.

The control unit 116 is configured to execute a set of instructions that are stored in one or more data storage units or elements (such as one or more memories), in order to process data. For example, the control unit 116 may include or be coupled to one or more memories. The data storage units may also store data or other information as desired or needed. The data storage units may be in the form of an information source or a physical memory element within a processing machine.

The set of instructions may include various commands that instruct the control unit 116 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 116. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 116 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 7 illustrates a perspective front view of an aircraft 600, according to an example of the present disclosure. The aircraft 600 can be assembled in a factory, and supported by one or more vehicles 102 (as shown and described herein) during a manufacturing process. The aircraft 600 includes a propulsion system 612 that includes engines 614, for example. Optionally, the propulsion system 612 may include more engines 614 than shown. The engines 614 are carried by wings 616 of the aircraft 600. In other examples, the engines 614 may be carried by a fuselage 618 and/or an empennage 620. The empennage 620 may also support horizontal stabilizers 622 and a vertical stabilizer 624. The fuselage 618 of the aircraft 600 defines an internal cabin 630, which includes a flight deck or cockpit, one or more work sections (for example, galleys, personnel carry-on baggage areas, and the like), one or more passenger sections (for example, first class, business class, and coach sections), one or more lavatories, and/or the like.

FIG. 7 shows an example of an aircraft 600. It is to be understood that the aircraft 600 can be sized, shaped, and configured differently than shown in FIG. 7. Optionally, vehicles 102 as described herein can be used during a manufacturing process of various other vehicles, such as automobiles, buses, locomotives, train cars, watercraft, spacecraft, and/or the like. As another example, the vehicles 102 as described herein can be used to support various other structures, whether part of vehicles, or not. As another example, the vehicles 102 described herein can be used in settings other than manufacturing. For example, the vehicles 102 can be used as automobiles (such as self-guiding electric cars) on roads having alignment strips, as shown, and described.

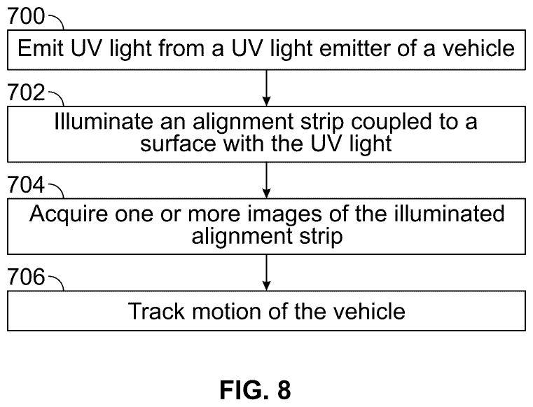

FIG. 8 illustrates a flow chart of a method, according to an example of the present disclosure. Referring to FIGS. 1 and 8, at 700, the UV light emitter 114 of the vehicle 102 emits the UV light 115 onto the surface 104. At 702, the alignment strip 118 coupled to the surface 104 is illuminated by the UV light 115. At 704, the imaging device 112 acquires one or more images of the illuminated alignment strip 118. At 706, the control unit 116 tracks motion of the vehicle 102, such as through image analysis of the acquired images. The method can also include automatically controlling operation of the vehicle 102, such as through use of the acquired images.

Further, the disclosure comprises examples according to the following clauses:

Clause 1. A system comprising:
an alignment strip coupled to a surface; and
a vehicle configured to move over the surface, wherein the vehicle comprises:
   an ultraviolet (UV) light emitter configured to emit UV light onto the alignment strip, wherein the UV light emitted by the UV light emitter illuminates the alignment strip; and
   an imaging device configured to acquire one or more images of the alignment strip as illuminated by the UV light.

Clause 2. The system of Clause 1, further comprising a control unit in communication with the imaging device, wherein the control unit is configured to receive image data including the one or more images from the imaging device, and wherein the control unit is further configured to use the one or more images to one or both of track movement of the vehicle, or control the movement of the vehicle.

Clause 3. The system of Clauses 1 or 2, wherein the surface is a floor within a factory.

Clause 4. The system of Clauses 1 or 2, wherein the surface is a road.

Clause 5. The system of any of Clauses 1-4, wherein the imaging device is an equipment camera configured to acquire black and white images or videos.

Clause 6. The system of any of Clauses 1-5, wherein the UV light emitter is configured to emit the UV light at a wavelength of 365 nanometers.

Clause 7. The system of any of Clauses 1-6, wherein the alignment strip is retained within a channel formed into a top of the surface.

Clause 8. The system of any of Clauses 1-7, wherein the alignment strip is an acrylic strip.

Clause 9. The system of Clause 8, wherein the acrylic strip is colored fluorescent neon green.

Clause 10. The system of Clauses 8 or 9, wherein the surface comprises a dark backdrop against the acrylic strip.

Clause 11. A method for a system comprising:
an alignment strip coupled to a surface; and
a vehicle configured to move over the surface, wherein the vehicle comprises:
   an ultraviolet (UV) light emitter configured to emit UV light onto the alignment strip, wherein the UV light emitted by the UV light emitter illuminates the alignment strip; and
   an imaging device configured to acquire one or more images of the alignment strip as illuminated by the UV light, the method comprising:
emitting, by the UV light emitter, UV light onto the alignment strip;
illuminating, by the UV light, the alignment strip; and
acquiring, by the imaging device, one or more images of the alignment strip as illuminated by the UV light.

Clause 12. The method of Clause 11, further comprising:
receiving, by a control unit in communication with the imaging device, image data including the one or more images from the imaging device; and
using, by the control unit, the one or more images to one or both of track movement of the vehicle, or control the movement of the vehicle.

Clause 13. The method of Clauses 11 or 12, wherein the surface is a floor within a factory.

Clause 14. The method of Clauses 11 or 12, wherein the surface is a road.

Clause 15. The method of any of Clauses 11-14, wherein the imaging device is an equipment camera configured to acquire black and white images or videos.

Clause 16. The method of any of Clauses 11-15, wherein the UV light emitter is configured to emit the UV light at a wavelength of 365 nanometers.

Clause 17. The method of any of Clauses 11-16, wherein the alignment strip is retained within a channel formed into a top of the surface.

Clause 18. The method of any of Clauses 11-17, wherein the alignment strip is an acrylic strip that is colored fluorescent neon green.

Clause 19. The method of Clause 18, wherein the surface comprises a dark backdrop against the acrylic strip.

Clause 20. A system comprising:
an alignment strip retained within a channel formed into a top of a surface, wherein the alignment strip is formed of fluorescent neon green acrylic, and wherein the surface includes a dark backdrop against the alignment strip; and
a vehicle configured to move over the surface, wherein the vehicle comprises:
   an ultraviolet (UV) light emitter configured to emit UV light onto the alignment strip, wherein the UV light emitter is configured to emit the UV light at a wavelength of 365 nanometers, and wherein the UV light emitted by the UV light emitter illuminates the alignment strip;
   an imaging device configured to acquire one or more images of the alignment strip as illuminated by the UV light; and
   a control unit in communication with the imaging device, wherein the control unit is configured to receive image data including the one or more images from the imaging device, and wherein the control unit is further configured to use the one or more images to one or both of track movement of the vehicle, or control the movement of the vehicle.

As described herein, examples of the present disclosure provide efficient and effective systems and methods for ensuring a desired alignment of a vehicle, such as an automated guided vehicle. Further, examples of the present disclosure provide systems and methods that provide a robust, resilient, and effective alignment indicia for a vehicle. Also, examples of the present disclosure provide systems and methods that lead to an efficient and effective manufacturing process, such as for an aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an alignment strip coupled to a surface; and
a vehicle configured to move over the surface, wherein the vehicle comprises:
an ultraviolet (UV) light emitter configured to emit UV light onto the alignment strip, wherein the UV light emitted by the UV light emitter illuminates the alignment strip; and
an imaging device configured to acquire one or more images of the alignment strip as illuminated by the UV light.

2. The system of claim 1, further comprising a control unit in communication with the imaging device, wherein the control unit is configured to receive image data including the one or more images from the imaging device, and wherein the control unit is further configured to use the one or more images to one or both of track movement of the vehicle, or control the movement of the vehicle.

3. The system of claim 1, wherein the surface is a floor within a factory.

4. The system of claim 1, wherein the surface is a road.

5. The system of claim 1, wherein the imaging device is an equipment camera configured to acquire black and white images or videos.

6. The system of claim 1, wherein the UV light emitter is configured to emit the UV light at a wavelength of 365 nanometers.

7. The system of claim 1, wherein the alignment strip is retained within a channel formed into a top of the surface.

8. The system of claim 1, wherein the alignment strip is an acrylic strip.

9. The system of claim 8, wherein the acrylic strip is colored fluorescent neon green.

10. The system of claim 8, wherein the surface comprises a dark backdrop against the acrylic strip.

11. A method for a system comprising:
an alignment strip coupled to a surface; and
a vehicle configured to move over the surface, wherein the vehicle comprises:
an ultraviolet (UV) light emitter configured to emit UV light onto the alignment strip, wherein the UV light emitted by the UV light emitter illuminates the alignment strip; and
an imaging device configured to acquire one or more images of the alignment strip as illuminated by the UV light,
the method comprising:
emitting, by the UV light emitter, UV light onto the alignment strip;
illuminating, by the UV light, the alignment strip; and
acquiring, by the imaging device, one or more images of the alignment strip as illuminated by the UV light.

12. The method of claim 11, further comprising:
receiving, by a control unit in communication with the imaging device, image data including the one or more images from the imaging device; and
using, by the control unit, the one or more images to one or both of track movement of the vehicle, or control the movement of the vehicle.

13. The method of claim 11, wherein the surface is a floor within a factory.

14. The method of claim 11, wherein the surface is a road.

15. The method of claim 11, wherein the imaging device is an equipment camera configured to acquire black and white images or videos.

16. The method of claim 11, wherein the UV light emitter is configured to emit the UV light at a wavelength of 365 nanometers.

17. The method of claim 11, wherein the alignment strip is retained within a channel formed into a top of the surface.

18. The method of claim 11, wherein the alignment strip is an acrylic strip that is colored fluorescent neon green.

19. The method of claim 18, wherein the surface comprises a dark backdrop against the acrylic strip.

20. A system comprising:
an alignment strip retained within a channel formed into a top of a surface, wherein the alignment strip is formed of fluorescent neon green acrylic, and wherein the surface includes a dark backdrop against the alignment strip; and
a vehicle configured to move over the surface, wherein the vehicle comprises:
an ultraviolet (UV) light emitter configured to emit UV light onto the alignment strip, wherein the UV light emitter is configured to emit the UV light at a wavelength of 365 nanometers, and wherein the UV light emitted by the UV light emitter illuminates the alignment strip;
an imaging device configured to acquire one or more images of the alignment strip as illuminated by the UV light; and
a control unit in communication with the imaging device, wherein the control unit is configured to receive image data including the one or more images from the imaging device, and wherein the control unit is further configured to use the one or more images to one or both of track movement of the vehicle, or control the movement of the vehicle.
